(19) United States
(12) Patent Application Publication
(10) Pub. No.: US 2018/0085841 A1
(43) Pub. Date: Mar. 29, 2018

(54) Adjustable Circular Burner Attachment

(71) Applicant: Michael Lewis Parker, Suffolk, VA (US)

(72) Inventor: Michael Lewis Parker, Suffolk, VA (US)

(21) Appl. No.: 15/607,587

(22) Filed: May 29, 2017

Related U.S. Application Data
(60) Provisional application No. 62/495,906, filed on Sep. 29, 2016.

(51) Int. Cl. B23K 7/10

(52) U.S. Cl. CPC B23K 7/107

(57) ABSTRACT

The Adjustable Circular Burner Attachment is a device that attaches to double-barrel burning torches to give an operator the ability to cut circles into steel or other metals. The attachment is adjustable to allow for different size circles to be cut. The attachment gives added stability for better quality cuts and a safer environment for the operator by becoming a part of the burning torch.

### FIELD

The present application relates to an attachment for steel cutting and burning operations, in particular with an operation in cutting circles with adjustability and stability.

### BACKGROUND

Steel cutting and burning torches are extensively used in industrial and construction environments. The steel cutting and burning torches are used to cut shapes and trim edges on steel products. Earlier circle cutting and burning attachments were designed in such a way that too much motion or tension would cause them to become unstable and loosen up. The stability of the cutting and burning torches are critical for the cutting and burning of steel for both safety and quality of work. Past attachments for torches have led to quality issues where additional grinding operations had to ensue to perform clean up on uneven cuts and excess slag. Past attachments also tend to come loose and move due to tension and wear and tear, leading to safety issues.

### SUMMARY

The Adjustable Circular Burner Attachment is an attachment made to fit double-barreled burning torches. The attachment allows the operator to burn circles in steel or other metals. The Adjustable Circular Burner Attachment easily attaches to the burning torches by fitting around the barrels of the burning torch. This allows the attachment to become part of the burning torch to help the operator have more control and stability over the torch during operations. This functionality allows for better quality cuts and safety of the operator. With the attachment acting like a piece of the burning torch, it gives the operator the ability to fully concentrate on the task of burning the circle instead of focusing on using an attachment to help make the burner cut circles.

The attachment is adjustable in multiple ways. It can first adjust with how far up or down the operator wants the attachment on the barrel of the torch or it can be adjusted by moving the round steel bar with a beveled tip on the bottom of the attachment. Both forms of adjustment will allow for the operator to choose how large or small of a circle they would like to cut.

### BRIEF DESCRIPTION OF THE DRAWINGS

In the following detailed portion of the present description, the teachings of the present application will be explained in more detail with reference to the drawings, in which:

FIG. 1 is an isometric view of the front of the Adjustable Circular Burner Attachment,

FIG. 2 is an isometric view of the side of the Adjustable Circular Burner Attachment, and

FIG. 3 is an isometric view of the bottom of the Adjustable Circular Burner Attachment.

### DETAILED DESCRIPTION

In the following detailed description, the attachment according to the teachings for this application in the form of an adjustable circular burner attachment will be described.

A front view of the burner attachment 200 is illustrated in FIG. 1. The burner attachment 200 comprises an aluminum frame 201, a detachable aluminum bar 202, thumbscrew holes 203 that are used to attach the detachable aluminum bar 202 to the aluminum frame 201, a steel round bar 204 with a beveled tip 205, and a steel nut 206. The steel round bar 204 with beveled tip 205 is held to the aluminum frame 201 by a steel nut 206.

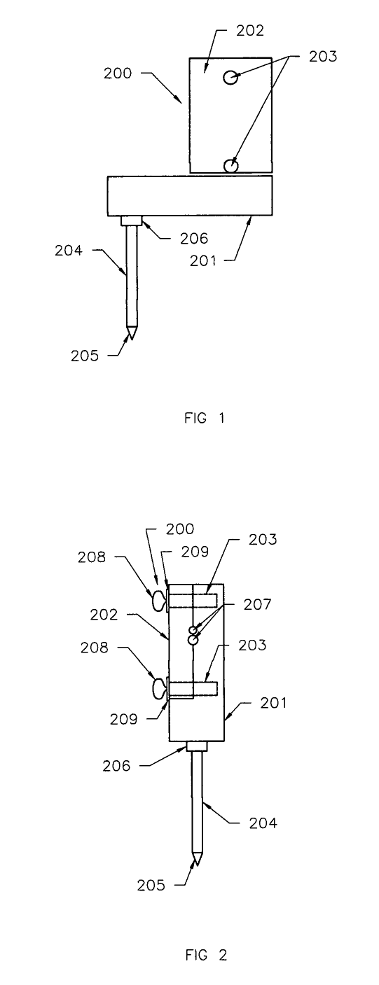

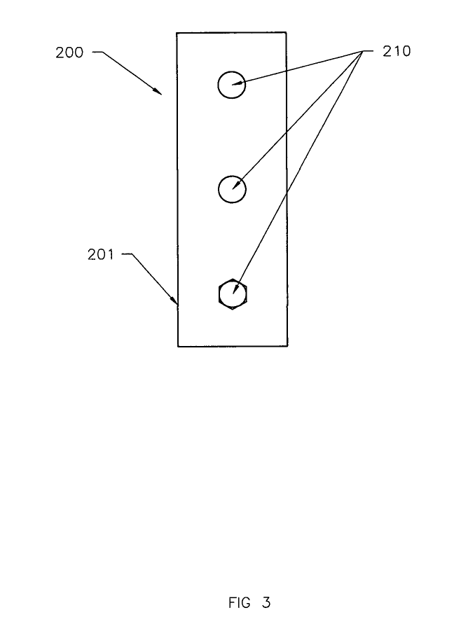

A side view of the burner attachment 200 is illustrated in FIG. 2. The detachable aluminum bar 202 is held to the aluminum frame 201 by thumbscrews 208 which are screwed into thumbscrew holes 203. The thumbscrew holes 203 go all the way through the detachable aluminum bar 202 and most of the way through the aluminum frame 201. Washers 209 are added between the thumbscrews 208 and the detachable aluminum bar 202 to ensure loosening doesn't occur. Torch barrel holes 207 are located between the detachable aluminum bar 202 and the aluminum frame 201 to allow placement of torch barrels. The round steel bar 204 with beveled tip 205 is held to the aluminum frame 201 by a steel nut 206.

A bottom view of the burner attachment 200 is illustrated in FIG. 3. This view shows the bottom of the aluminum frame 201 as it pertains to the burner attachment 200. Three holes 210 are on the bottom of the aluminum frame 201 to allow adjustment of the steel round bar 204 with beveled tip 205.

The burner attachment 200 is made primarily of aluminum. The aluminum frame 201 and the detachable aluminum bar 202 are made of aluminum. The aluminum frame 201 is cut to form a backwards L. The horizontal part of the backwards L is to be ¾ of an inch high, 1 inch thick, and 3 inches long. The vertical part of the backwards L is to be 1.5 inches wide, 2 inch and ¼^{th} high and ½ of an inch thick. The detachable aluminum bar 202 needs to be cut to measure 2 inches and 3/16^{th} high, 1.5 inches wide, and 5/16^{th} of an inch thick. Both the aluminum frame 201 and the detachable aluminum bar 202 needs to have 2 holes drilled through them to allow the thumbscrews 208 to be screwed in. The detachable aluminum bar 202 will need larger holes than the aluminum frame 201 for the thumbscrews 208 to pass through easily. The thumbscrew holes 203 on the detachable aluminum bar 202 should be ¼^{th} wide and 1 inch and 11/16^{th} apart from each other. The center of the top thumbscrew holes 203 should be 5/16^{th} from the top of the detachable aluminum bar 202. The thumbscrew holes 203 on the aluminum frame 201 should be drilled to 3/16ths to allow the thumbscrews 208 to screw into the holes. On the bottom of the aluminum frame 201 are 3 holes 210 to allow the round steel bar 204 with beveled tip 205 to be adjusted. The three holes 210 should be drilled to ¼^{th} size and should be spaced 1 inch from each other with the first hole starting 7/16^{th} from the end of the aluminum frame 201. Once all pieces have been cut and drilled the last thing to prepare are the holes for the torch barrels 207. These holes should be cut to specifically fit the torches needed.

The teaching of the present application has numerous advantages. It should be noted that this is not an exhaustive list and there may be other advantages that are not described herein. For example, one advantage of this teaching of this application is it provides for a 2-barreled cutting torch to be placed in between the aluminum frame 201 and the detachable aluminum bar 202. This allows the operator of the burning torch to have a sturdy hold on the burning torch and provide added stability while the operator is turning to cut circles. Another advantage is the round steel bar 204 with a beveled tip 205. This is used to keep the piece stationary while rotating to cut circles with a burning torch. This is done so by applying a punch hole to the item being cut. The punch hole needs to be less than the circumference of the round steel bar 204, so the beveled tip 205 can fit into the punch hole and allow the round steel bar 204 to still be fully visible above the item being cut. Another advantage is how the aluminum frame 201 and the detachable aluminum bar 202 come together over the 2 barrels to make it one cohesive unit. The aluminum is lightweight, which gives less resistance while performing cutting operations but is sturdy enough to take a beating in the operating environment.

The Adjustable Circular Burner Attachment is adjustable in multiple ways. The burner attachment 200 can adjust on the burning torch barrels. The burner attachment 200 can either be adjusted close to the handgrip of the burning torch for large circles or close to the burning torch's head for smaller circles. To increase the tightness of the circle or to decrease the size of the circumference, the operator may adjust the round steel bar 204 and beveled tip 205. This is done by loosing the steel nut 206 and pulling the round steel bar 204 and beveled tip 205 out of one of the three holes 210 and moving the round steel bar 204 and beveled tip 205 into one of the other desired three holes 210.

The burner attachment 200 acts as an extension of the burning torch it is attached too. Where as other circular burning attachments act as an extra piece of equipment that needs to be operated simultaneously as the burning torch itself.

1. The Adjustable Circular Burner Attachment is an attachment made for double-barreled torch burning devices that is used to help the operator cut multiple sized circles out of metals with accuracy and stability.

2. The attachment according to claim 1, has an aluminum frame which is lightweight and sturdy.

3. The attachment according to claim 1, has an aluminum detachable bar that is held into position on the aluminum frame by using thumbscrews.

4. The attachment according to claim 1, the barrels of a torch-burning device is placed in between the aluminum frame and the detachable aluminum bar.

5. The attachment according to claim 4, has thumbscrews that hold the aluminum frame, torch burning device barrels, and the detachable aluminum frame together.

6. The attachment according to claim 5, in between each thumbscrew and the detachable aluminum bar is a washer to allow the operator the ability to fully tighten the attachment to the torch burning barrels.

7. The attachment according to claim 2, the aluminum frame is adjustable up and down the barrel's of the torch burning device to allow for different circumferences to be cut.

8. The attachment according to claim 2, has three evenly space holes on the bottom of the frame to insert a round steel bar with a beveled tip.

9. The attachment according to claim 8, the round steel bar with beveled tip is adjustable between any of the three aforementioned holes to give added adjustability to the circles circumference.

10. The attachment according to claim 9, the round steel bar with a beveled tip is held into the aluminum frame of the attachment by a steel nut.

11. The attachment according to claim 10, the steel nut is tightened onto the round steel bar to give stability to the round steel bar for operation.

12. The attachment according to claim 11, the beveled tip on the round steel bar is placed into a center punch hole by the operator to give stability while turning during the cutting operation.
